(19) United States
(12) Patent Application Publication
(10) Pub. No.: US 2010/0027437 A1
(43) Pub. Date: Feb. 4, 2010

(54) Systems and Methods for Determining Link Quality

(75) Inventor: Ovidiu Ratiu, Marietta, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Nivis, LLC, Atlanta, GA (US)

(21) Appl. No.: 12/533,363

(22) Filed: Jul. 31, 2009

Related U.S. Application Data
(60) Provisional application No. 61/085,733, filed on Aug. 1, 2008.

(51) Int. Cl. H04L 12/26

(52) U.S. Cl. 370/252

(57) ABSTRACT

Systems and methods for determining link quality are disclosed. In one embodiment, a method includes the steps of transmitting a first quantity of messages to a remote device, receiving a second quantity of message acknowledgements from the remote device, determining a receive signal strength indicator (RSSI) value, comparing the RSSI value to a minimum RSSI threshold. If the RSSI value is greater than the minimum RSSI threshold, calculating an end-to-end link quality (EELQ) based at least in part on the percentage of message acknowledgements received and the link quality of the previous link in the network, determining a message success rate based on the first quantity and the second quantity, receiving a link quality from the remote device, and determining an end-to-end link quality (EELQ) value based at least in part on a previous EELQ value and the message success rate. Otherwise the EELQ value is set to 0. Then calculating an end-to-end link cost (EELC) value based at least in part on the EELQ; selecting a route based at least in part on the EELC; and transmitting a message to a second device on the route.

### CROSS-REFERENCE TO RELATED APPLICATIONS

This application claims priority to U.S. Provisional Patent Application No. 61/085,733, filed Aug. 1, 2008, entitled “Systems and Methods for Determining Link Quality,” the entirety of which is incorporated herein by reference.

### FIELD OF THE INVENTION

The present invention relates to systems and methods for determining link quality.

### BACKGROUND

Devices within a network may send and receive data over the network by communicating with each other over pre-defined routes. The routes between different devices may be determined by a router or other control system based on information about the network. For example, if there is no direct communications path between two devices, a router may select a communications route between the two devices by using the fewest number of intermediate devices, where an intermediate device may also be referred to as a ‘hop’.

In wireless networks, additional variables may be considered when identifying a route between two devices. For example, the quality of the wireless link between two devices may be considered. For example, it may be desirable to use a route with more hops than a shorter route, if the link quality between the devices along the longer route is better than the link quality of the shortest route between the devices.

### SUMMARY

Embodiments of the present invention provide systems and methods for determining link quality between distributed devices in a network. For example, in one embodiment, a method for determining link quality comprises the steps of transmitting a first quantity of messages to a remote device, receiving a second quantity of message acknowledgements from the remote device, determining a receive signal strength indicator (RSSI) value, comparing the RSSI value to a minimum RSSI threshold. If the RSSI value is greater than the minimum RSSI threshold, calculating an end-to-end link quality (EELQ) based at least in part on the percentage of message acknowledgements received and the link quality of the previous link in the network, determining a message success rate based on the first quantity and the second quantity, receiving a link quality from the remote device, and determining an end-to-end link quality (EELQ) value based at least in part on a previous EELQ value and the message success rate. Otherwise the EELQ value is set to 0. The method further comprises calculating an end-to-end link cost (EELC) value based at least in part on the EELQ; selecting a route based at least in part on the EELC; and transmitting a message to a second device on the route. In another embodiment, a computer-readable medium comprises program code for executing such a method.

These illustrative embodiments are mentioned not to limit or define the invention, but to provide examples to aid understanding thereof. Illustrative embodiments are discussed in the Detailed Description, and further description of the invention is provided therein. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 shows a system for determining link quality according to one embodiment of the present invention;

FIG. 2 shows a system for determining link quality according to one embodiment of the present invention;

FIG. 3 shows a method for determining link quality according to one embodiment of the present invention; and

FIG. 4 shows a method for determining link quality according to one embodiment of the present invention.

### DETAILED DESCRIPTION

Embodiments of the present invention provide systems and methods for determining link quality. Embodiments disclosed herein are meant to be illustrative examples and not to limit the scope of the invention.

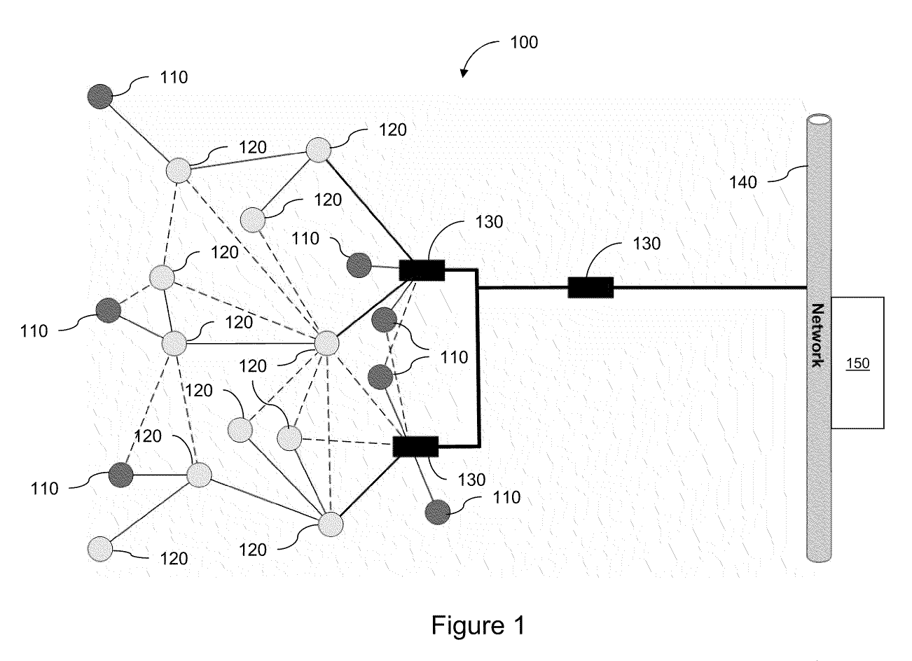

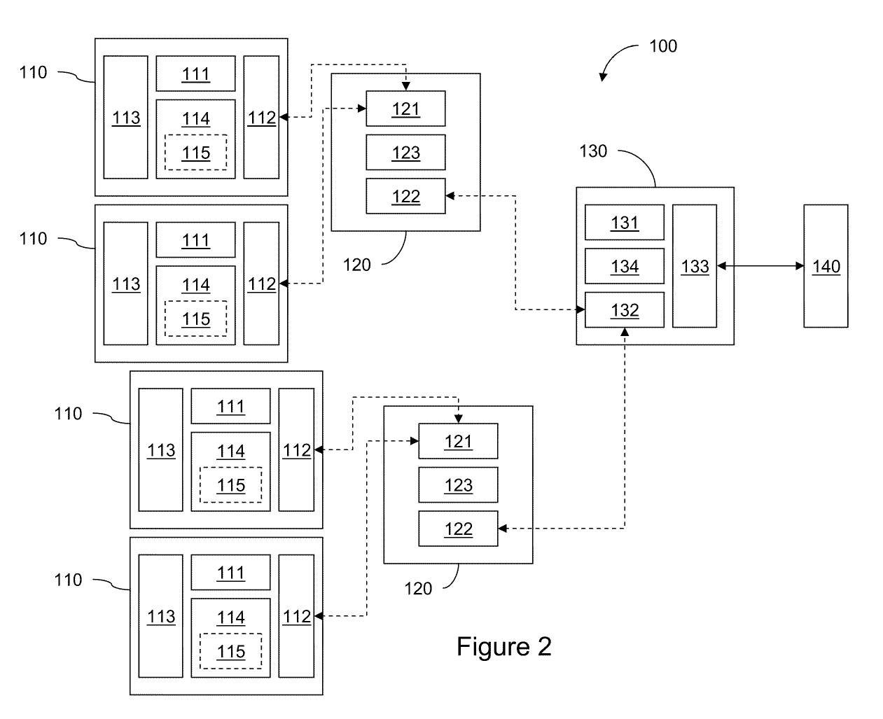

Referring now to FIG. 1, FIG. 1 shows a system 100 for determining link quality according to one embodiment of the present invention. The system 100 shown in FIG. 1 comprises a plurality of remote devices 110, also referred to as non-routing devices, a plurality of routing devices 120, a plurality of backbone routers 130, a network 140, and a control system 150. As may be seen in FIG. 1, each of the non-routing devices 110 is in communication with at least one routing device 120, and each of the routing devices 120 is in communication with at least one backbone router 130. The backbone router 130 then provides a communication path to the network 140. The control system 150 is in communication with the network 140 as well as each of the backbone routers 130, routing devices 120, and non-routing devices 110. A more detailed view of the components of the system 100 shown in FIG. 1 can be seen in FIG. 2.

FIG. 2 shows a system 100 for determining link quality according to one embodiment of the present invention. As can be seen in FIG. 2, the non-routing devices 110 each comprise a processor 111, a memory 114 comprising application software 115, a sensor 113, and a wireless communication device 112. The routing devices 120 each comprise a processor 121, a memory 123, and a wireless communication device 122. Additionally, in some embodiments, a routing device 120 may also comprise a sensor 113. The backbone router 130 comprises a processor 131, a memory 134, a wireless communication device 132, and a wired communication device 133.

In the non-routing devices 110 shown in FIGS. 1 and 2, the processor 111 is in communication with a memory 114 that comprises a computer-readable medium. The memory 114 stores software and other configuration information used by the processor 111 to perform various tasks to be executed by the non-routing device 110. For example, in one embodiment of the present invention, the processor 111 is configured to execute software 115 stored in memory 114 to determine link quality and cost, to read data from sensor 113, to store the sensor data in the memory 114, and to transmit the sensor data to the control system 150.

In the embodiment shown in FIGS. 1 and 2, the wireless communication devices 112 are in communication with the processor 111 and comprise wireless devices capable of communicating using the IEEE 802.15.4 protocol. However, other suitable wireless communication devices 112 maybe used, such as 802.11 wireless Ethernet transceiver, or cellular radios.

Non-routing devices 110 comprise sensors 113 capable of collecting data. For example, the non-routing devices 110 may be incorporated into a pipe running through a plant or factory. Non-routing devices 110 in such an embodiment may comprise pressure sensors capable of detecting internal gas or fluid pressures within the pipe. Non-routing devices 110 in other embodiments may comprise other types of sensors, or a plurality of sensors.

In the embodiment shown in FIGS. 1 and 2, routing devices 120 comprise a processor 121, a memory 123, and a wireless communication device 122. Some of the routing devices 120b further comprise a sensor 113. In the embodiment shown, a routing device 120 may comprise a non-routing device 110 that has been configured to act as a routing device. For example, the routing device 120b comprises a non-routing device 110, but a software configuration parameter stored in memory 123 of the non-routing device has been set to enable routing functionality. Similarly, in the embodiment shown, the non-routing devices 110 each may be capable of acting as routing devices; however, the routing capabilities have been disabled by a configuration setting.

The backbone routers 130 in the embodiment shown comprise a memory 134 in communication with the processor 131. In such an embodiment, the memory 134 is configured to store application software to be executed by the processor as well as data to be passed to the control device 150. The backbone routers 130 comprise a wireless communications device 132 for communicating with non-routing devices 110 and routing device 120. The backbone routers 130 also comprise a wired communication device 133 for communicating with the network 140 and the control system 150.

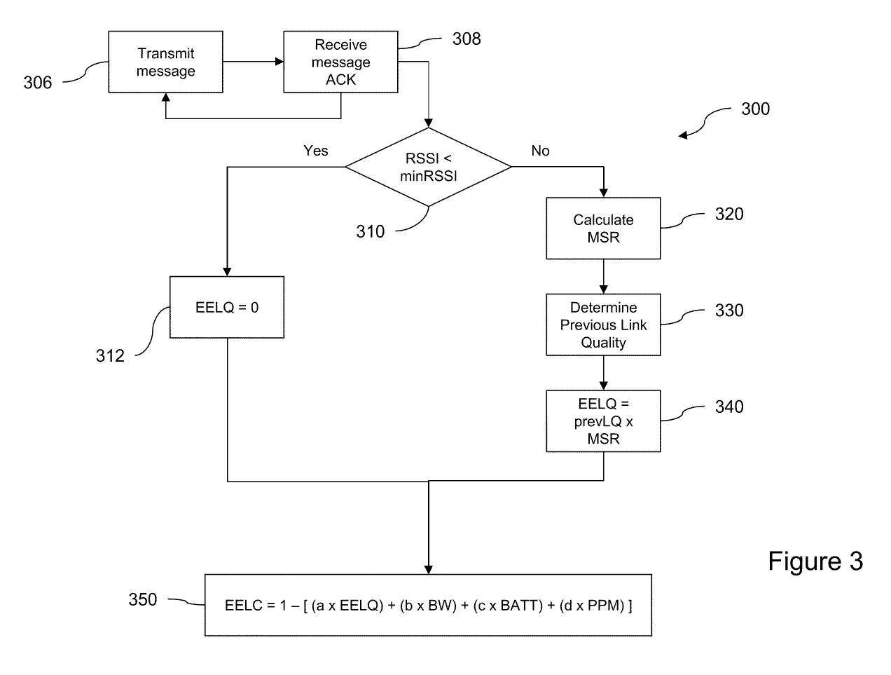

Referring now to FIG. 3, FIG. 3 shows a method for determining link quality according to one embodiment of the present invention. The method shown in FIG. 3 is configured to be loaded into memory and executed by a processor as a software application. The method 300 shown in FIG. 3 is described with respect to the system 100 shown in FIGS. 1 and 2.

The embodiment shown in FIG. 3 provides a method for determining link quality between a device and a backbone router 130. The link quality in this embodiment is referred to as the end-to-end link quality (EELQ) and is based at least in part on three values: the percentage of message acknowledgements received in a period of time, the link quality of the previous device in the network, and the receive strength signal indicator (RSSI) value. In this embodiment, a previous device is a device that is intermediate between the device calculating its EELQ and a backbone router. However, in another embodiment, a previous device could be a backbone router.

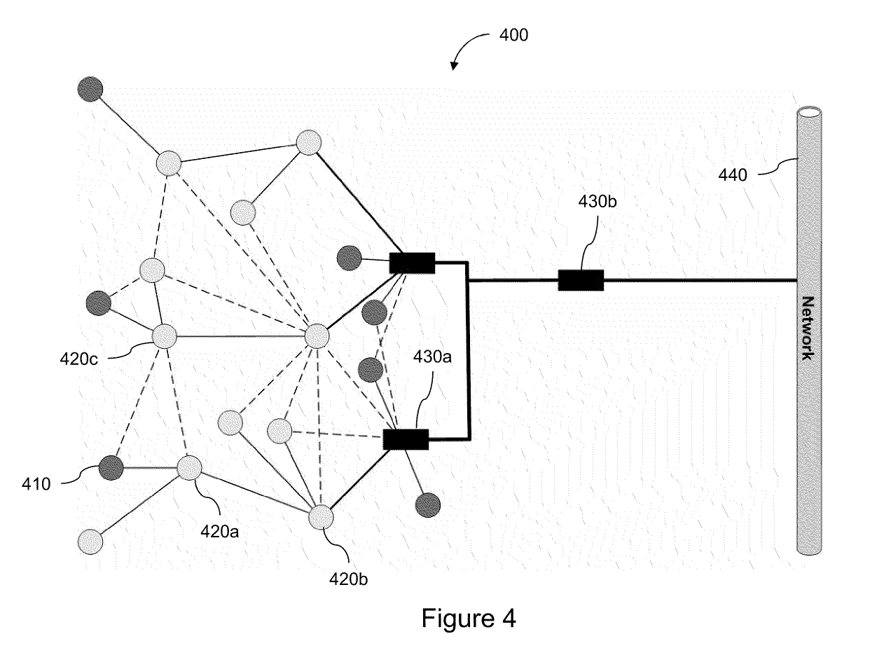

For example, FIG. 4 shows a system 400 including a non-routing device 410 that is determining its EELQ. The end-to-end link begins with backbone router 430, includes two routing devices 420a,b and terminates at the non-routing device 410. While a second backbone router 430b is located between the backbone router 430a and the network 440, the two backbone routers are connected by a wired connection and, in this embodiment, are presumed to have a maximum link quality of 1 between them.

In the embodiment shown in FIG. 4, while there are at least 2 routes between the non-routing device 410 and the backbone router 430, the route between the non-routing device 410 and the network has been selected to include routing devices 420a,b. FIG. 4 depicts routes as lines between different devices, where solid lines indicate the primary route between devices and dashed lines indicate alternate routes between devices. EELQ values based upon other routes are not calculated in the embodiment shown, though in other embodiments, a device may determine EELQ values for more than one route. Such an embodiment may allow a device to switch between routes as link qualities change. However, such an embodiment may require additional power to perform the necessary link quality analysis for multiple routes.

In the embodiment shown in FIG. 4, when the non-routing device 410 is computing its EELQ, the previous device is the routing device 420a that is the next communication hop towards the backbone router 430. If routing device 420a is determining its EELQ, routing device 420b is the previous device, and so forth.

Referring again to FIG. 3, the method 300 shown will be described with respect to FIGS. 2 and 4.

The method 300 begins in step 306 when a non-routing device 410 executes a software application 115 to determine an end-to-end link cost (EELC) of a route to the network 440. The processor 111 of the non-routing device 410 executes software 115 stored in its memory 114 and transmits a message to the next device 420a on its current route to the network. In step 308, the application 115 receives an acknowledgement (ACK) message from the next device 420a in response to the message. The application 115 may then transmit additional messages to the next device 420a and receives acknowledgements in return from the next device 420a. The application 115 counts the number of messages sent and the number of message acknowledgements received in memory locations within its memory 114. The application 115 may repeat steps 306 and 308 until a predetermined number of messages have been transmitted. After transmitting the predetermined number of messages, the application 115 proceeds to step 310. In another embodiment, the application 115 executes the method beginning at step 310.

In step 310, the application 115 performs measurements using its wireless communications device 112 and measures its RSSI value. After measuring its RSSI value, the application 115 compares its RSSI value against a minimum RSSI threshold, minRSSI, stored in its memory 114. In some embodiments, the value of minRSSI is a configurable value. If the RSSI value is less than minRSSI, the non-routing device sets its EELQ value to 0, which is the minimum value for EELQ in this embodiment and indicates that the link is not useable. If the RSSI value is greater than minRSSI, the application 115 proceeds to step 320.

If the method proceeds to step 320, the application 115 calculates a Message Success Rate (MSR) based on the quantity of messages transmitted and the quantity of ACK messages received. For example, in one embodiment of the present invention, the application 115 transmits a message to the next device 420 on the route and receives an ACK message from the next device 420 in response. In the embodiment shown, each time a message is sent, the application 115 increments a first counter, nr_sent_msg, up to a maximum value, SENT_MSG. Additionally, each time an ACK message is received, the application 115 increments a second counter, nr_ack_msg. The values of these two counters are stored by the processor 111 in memory 114. To calculate the MSR, the application 115 divides the number of acknowledged messages, nr_ack_msg, by the number of messages sent, mr_sent_msg (or SENT_MSG if the counter has reached the maximum value). Thus, if fewer ACK messages are received than messages were sent, it may indicate that the wireless link is operating with less than a 100% success rate. In this embodiment, the value of MSR will be a value between 0 and 1, though in other embodiments any suitable range of values may be used. Once the MSR has been calculated, the application 115 proceeds to step 330.

In step 330, the application 115 determines the end-to-end link quality reported by the next device 420a along the route. In one embodiment of the present invention, the application 115 receives the EELQ value from the next device 420a as a part of a periodic status message or as a part of a message acknowledgement. In another embodiment of the present invention, the application 115 may specifically request the EELQ value reported by the next device 420a along the route. In the embodiment shown, the next device's EELQ (prevLQ) comprises a value between 0 and 1. Once the EELQ value for the next device 420a is determined, the application 115 proceeds to step 340

In step 340, the application 115 calculates its EELQ value based at least in part on MSR and prevLQ. In the embodiment shown in FIG. 3, the application 115 calculates EELQ as the product of the previous device's EELQ and the device's MSR: EELQ=prevLQ*MSR. In other embodiments, other formulas may be used. For example, in one embodiment of the present invention, EELQ may be calculated according to the following formula:

EELQ=(x*prevLQ)*(y*MSR), where x and y are weighting factors.

Weighting factors x and y may be selected and stored in memory 114 to favor either the MSR or the prevEELQ value. For example, in one embodiment, the previous link quality value may be of diminished value because the message success rate is more important, and thus the value of y is greater than x. This may allow for an EELQ value to more quickly be updated for changing conditions. Alternatively, in another embodiment, it may be desirable to filter out sporadic poor MSR results, and so the previous link quality is weighted more heavily. Still further embodiments may employ additional variables or formulas. Finally, the step may proceed to step 350.

In step 350, the application 115 calculates its an end-to-end link cost (EELC) value. In the embodiment shown in FIG. 3, the application 115 calculates its EELC value based at least in part on the its calculatedd EELQ. For example, in one embodiment, EELC may be determined by the formula EELC=1−EELQ. In another embodiment, EELC may be determined according to the following equation:

EELC=1−[(a*EELQ)+(b*BW)+(c*BATT)+(d*PPM)], where a, b, c, and d are weighting factors, BW represents a percentage of available bandwidth, BATT represents a percentage of remaining battery life, and PPM represents the timing accuracy of the device's internal clock, such as a crystal oscillator. In this embodiment, the sum of the weighting factors a, b, c, and d is 1 (i.e. a+b+c+d=1). Further, in this embodiment, each of BW, BATT, EELQ, and PPM have values between 0 and 1, inclusive. While this equation represents one method of computing EELC, other methods are possible as well. For example, in another embodiment, EELC may be calculated based on a subset of these parameters, or on other suitable parameters. In one such embodiment, the BATT parameter may be eliminated if the device is not battery powered.

Unlike EELQ, EELC represents a cost of using a particular route, and includes other factors than just the quality of the end-to-end link. For example, in the embodiment shown in FIG. 3, the EELC is based on the EELQ, the available bandwidth along the route, the battery power of the devices comprising the route, and the relative accuracy of the non-routing device's internal clock's crystal oscillator (measured in parts-per-million). Each of the factors comprises a value from 0 to 1. Further, each of the factors is scaled by a weight between 0 and 1.

Once the EELC has been calculated, it may be used to select a route to a device from a plurality of available routes. For example, if two routes are available, such as via devices 420a and 420c, the application 115 may transmit to the next device 420a or 420c depending on which is the next device along the route having the lowest EELC. For example, if the EELC for transmitting along the route from the non-routing device 410 to device 420a is 0.4 and the EELC for transmitting along the route from the non-routing device 410 to device 420c is 0.2, the application 115 selects the route comprising device 420c and transmits its messages to device 420c. Thus, based on the EELC value, the non-routing device can transmit its messages to the next device along a route that will consume the fewest network resources, such as battery power and bandwidth, to minimize the number of lost messages or message re-transmissions, or to reduce power requirements for a transmitting device.

Systems and methods for determining link quality according to embodiments of the present invention may be repeated over time to ensure that the EELC for various routes are kept up to date based on changing network conditions or configurations. For example, the application 115 may re-calculate EELC values for one or more available next devices (e.g. devices 420a and 420c) every 30 seconds.

Some portions of this detailed description were presented in terms of algorithms or symbolic representations of operations on data bits or binary signals stored within a computer in system memory, such as a computer memory. These algorithmic descriptions or representations are examples of techniques used by those of ordinary skill in the data processing arts to convey the substance of their work to others skill in the art. An algorithm is here and generally is considered to be a self-consistent sequence of operations or similar processing leading to a desired result. In this context, operations or processing involve physical manipulation of physical quantities, such as crystal oscillations or manipulation of radio transceivers and associated circuitry.

Typically, although not necessarily, such quantities may take the form of electrical or magnetic signals capable of being stored, transferred, combined, compared or otherwise manipulated. It has proven convenience at times, principally for reasons of common usage to refer to such signals as bits, data, values, elements, symbols, characters, terms numbers, numerals or the like. It should be understood, however, that all of these and similar terms are to be associated with appropriate physical quantities and are merely convenience labels.

Unless specifically stated otherwise, as apparent from the foregoing discussion, it is appreciated that throughout this specification discussions using terms such as “processing,” “computing,” “calculating,” “determining” or the like refer to actions or processes of a computing platform such as one or more computers and/or a similar electronic computing device or devices, that manipulate or transform data represented as physical electronic or magnetic quantities within memories, registers, or other information storage devices, transmission devices, or displayed devices of the computing platform.

The various systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

As noted above, a computing device may access one or more computer-readable media that tangibly embody computer-readable instructions which, when executed by at least one computer, case the at least one computer to implement one or more embodiments of the present subject matter. When software is used, the software may comprise one or more components, processes and/or applications. Additionally or alternatively to software, the computing device(s) may comprise circuitry that renders the device(s) operative to implement one or more of the methods of the present subject matter.

The technology referenced herein also makes reference to communicating data between components or systems. It should be appreciated that such communications may occur over any suitable number or type of networks or links, including, but not limited to, a dial-in network, a local area network (LAN), a wide area network (WAN), public switched telephone network (PSTN), the Internet, an intranet or combination of hard-wired and/or wireless communication links.

Any tangible computer-readable medium or media may be used to implement or practice the subject matter disclosed herein, including, but not limited to, diskettes, drives, magnetic-based storage media, optical storage media, including disks (including CD-ROMs, DVD-ROMs, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

### General

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A computer-implemented method comprising:
transmitting a first quantity of messages to a remote device;
receiving a second quantity of message acknowledgements from the remote device in response to receiving the first quantity of messages;
determining a receive signal strength indicator (RSSI) value;
comparing the RSSI value to a minimum RSSI threshold;
if the RSSI value is greater than the minimum RSSI threshold:
calculating an end-to-end link quality (EELQ) based at least in part on the percentage of message acknowledgements received and the link quality of the previous link in the network,
determining a message success rate based on the first quantity and the second quantity,
receiving a link quality from the remote device,
determining an end-to-end link quality (EELQ) value based at least in part on a previous EELQ value and the message success rate;
otherwise setting the EELQ value to 0;
calculating an end-to-end link cost (EELC) value based at least in part on the EELQ;
selecting a route based at least in part on the EELC; and
transmitting a message to a second device on the route selected.

2. The computer-implemented method of claim 1, wherein calculating the EELC is based at least in part on the EELQ, a bandwidth value, an expected battery life, and a crystal oscillator accuracy.

3. The computer-implemented method of claim 2, wherein calculating the EELC is based at least in part on a plurality of weighting factors.

4. The computer-implemented method of claim 1, wherein the method is executed a plurality of times to calculate a plurality of EELC values, each corresponding to one of a plurality of remote devices.

5. The computer-implemented method of claim 1, further comprising requesting the link quality from the remote device.

6. A computer-readable medium comprising program code, the program code comprising:
program code for transmitting a first quantity of messages to a remote device;
program code for receiving a second quantity of message acknowledgements from the remote device;
program code for determining a receive signal strength indicator (RSSI) value;
program code for comparing the RSSI value to a minimum RSSI threshold;
if the RSSI value is greater than the minimum RSSI threshold:
program code for calculating an end-to-end link quality (EELQ) value based at least in part on the percentage of message acknowledgements received and the link quality of the previous link in the network, the program code for calculating the EELQ value configured to execute if the RSSI value is greater than the minimum RSSI threshold;
program code for determining a message success rate (MSR) value based on the first quantity and the second quantity, the program code for determining the MSR value configured to execute if the RSSI value is greater than the minimum RSSI threshold;
program code for receiving a link quality from the remote device, the program code for receiving the link quality configured to execute if the RSSI value is greater than the minimum RSSI threshold,
program code for determining an end-to-end link quality (EELQ) value based at least in part on a previous EELQ value and the message success rate, the program code for determining the EELQ value configured to execute if the RSSI value is greater than the minimum RSSI threshold;
program code for setting the EELQ value to 0, the program code for setting the EELQ value to 0 if the RSSI value is less than the minimum RSSI threshold;
program code for calculating an end-to-end link cost (EELC) value based at least in part on the EELQ;
program code for selecting a route based at least in part on the EELC; and
program code for transmitting a message to a second device on the route.

7. The computer-readable medium of claim 6, wherein the program code for calculating the EELC is configured to calculate the EELC based at least in part on the EELQ, a bandwidth value, an expected battery life, and a crystal accuracy.

8. The computer-readable medium claim 7, wherein the program code for calculating the EELC is configured to calculate the EELC based at least in part on a plurality of weighting factors.

9. The computer-readable medium of claim 6, wherein the program code is configured to be executed a plurality of times to calculate a plurality of EELC values, each corresponding to one of a plurality of remote devices.

10. The computer-readable medium of claim 6, further comprising program code for requesting the link quality from the remote device.

11. A system comprising:
a memory;
a wireless receiver; and
a processor in communication with the memory and the wireless receiver, the processor configured to:
transmit a first quantity of messages to a remote device;
receive a second quantity of message acknowledgements from the remote device;
determine a receive signal strength indicator (RSSI) value;
compare the RSSI value to a minimum RSSI threshold;
calculate an end-to-end link quality (EELQ) value based at least in part on the percentage of message acknowledgements received and the link quality of the previous link in the network if the RSSI value is greater than the minimum RSSI threshold;
determine a message success rate (MSR) value based on the first quantity and the second quantity if the RSSI value is greater than the minimum RSSI threshold;
receive a link quality from the remote device if the RSSI value is greater than the minimum RSSI threshold,
determine an end-to-end link quality (EELQ) value based at least in part on a previous EELQ value and the message success rate if the RSSI value is greater than the minimum RSSI threshold;
set the EELQ value to 0 if the RSSI value is less than the minimum RSSI threshold;
calculate an end-to-end link cost (EELC) value based at least in part on the EELQ;
select a route based at least in part on the EELC; and
transmit a message to a second device on the route.

12. The system of claim 11, wherein the processor calculates the EELC based at least in part on the EELQ, a bandwidth value, an expected battery life, and a crystal accuracy.

13. The system of claim 12, wherein the processor calculates the EELC based at least in part on a plurality of weighting factors.

14. The system of claim 11, wherein the processor is configured to calculate a plurality of EELC values, each corresponding to one of a plurality of remote devices.

15. The system of claim 11, further configured to request the link quality from the remote device.
